(19) United States
(12) Patent Application Publication
(10) Pub. No.: US 2016/0101871 A1
(43) Pub. Date: Apr. 14, 2016

(54) ASSISTANCE DEVICE FOR OPERATING A COWL AND A NACELLE FOR TURBOJET ENGINE EQUIPPED THEREWITH

(71) Applicant: AIRCELLE, GONFREVILLE L'ORCHER (FR)

(72) Inventors: Patrick BOILEAU, TOURNEFEUILLE (FR); Samuel BLONDEAU, PIBRAC (FR)

(73) Assignee: AIRCELLE, GONFREVILLE L'ORCHER (FR)

(21) Appl. No.: 14/974,352

(22) Filed: Dec. 18, 2015

Related U.S. Application Data
(63) Continuation of application No. PCT/FR2014/051689, filed on Jul. 1, 2014.

(30) Foreign Application Priority Data
Jul. 1, 2013 (FR) 13/56383

(51) Int. Cl. B64D 29/06; F01D 25/24; E05F 3/18; E05D 7/00; E05F 3/20

(52) U.S. Cl. CPC B64D 29/06; E05D 7/00; E05F 3/20; E05F 3/18; F01D 25/24; F05D 2220/323

(57) ABSTRACT

An assistance device is provided to maneuver of a cover of a nacelle of a turbojet engine. The assistance device includes a joint collinear with an existing joint or hinge for a fitting of the cover, and the joint of the device is rigidly secured to an angled part of which one end bears on the fitting of the cover and of which one point is hinged to a compression spring in order to apply assistance momentum to the fitting of the cover when the cover is raised.

### CROSS-REFERENCE TO RELATED APPLICATIONS

This application is a continuation of International Application No. PCT/FR2014/051689, filed on Jul. 1, 2014, which claims the benefit of FR 13/56383, filed on Jul. 1, 2013. The disclosures of the above applications are incorporated herein by reference.

### FIELD

The present disclosure relates to an assistance device for operating a cowl, particularly a fan cowl on a turbojet engine nacelle or a similar device. It also concerns a turbojet engine nacelle equipped therewith.

### BACKGROUND

The statements in this section merely provide background information related to the present disclosure and may not constitute prior art.

Cowls are disposed on turbojet engine nacelles. Such cowls provide the continuity of the aerodynamic skin of the nacelle, when they are closed and during the flight of the equipped aircraft. When the aircraft is on the ground, it undergoes maintenance visits or the like and some inner members of the nacelle must be then accessible through the opening of the protective cowl.

To this end, the cowl is mounted on one or more hinges mounted on a stationary or support portion of the nacelle. In the case for example of the fan cowl, the size of the cowl is relatively large so that a significant mass must be operated. In addition, the wind resistance is also a problem so that many maintenance operators are mobilized to open a single cowl particularly for large-sized nacelles.

However, the opening and the closing operations increase the working time of the operator, so that they have a significant cost for the exploitation of a commercial aircraft.

To overcome this problem, the human intervention in particular must be then limited for handling the cowl. Cylinders may be provided for fully automatic operation, the operator intervention being limited to activate a control lever which actuates the cylinders.

Such solution cannot be easily implemented on an already existing nacelle, since it requires the setting-up of cylinders and their fastenings on the cowl to be mobilized as well as on the stationary portion relative to the cowl. Furthermore, the actuating cylinders are relatively heavy devices which increase the mass balance of the aircraft, which is to be proscribed.

Furthermore, the cowl itself has the strictly needed amount of material to achieve the two aforementioned functions of continuity of the aerodynamic skin in flight and of handling for the maintenance operations. It is difficult to add the securing portions of a drive cylinder on such cowl, particularly because the used skin is very low-reinforced and the action of the lifting cylinder could lead to piercing or damaging the cowl. The addition of a reinforcement at the design requires a new setting-up study and further increases the onboard mass of the aircraft.

### SUMMARY

The present disclosure provides an assistance device for operating a cowl of a turbojet engine nacelle hinged by means of at least one fitting. The assistance device of the present disclosure includes:
at least one elbow piece mounted on a hinge coaxial to the hinge of said fitting and having one end bearing on said fitting, and
a compression spring applied on said elbow piece to exert on the cowl fitting an assistance momentum when the cowl is lifted.

According to other features:

the application of the compression spring on said elbow piece includes a hinge of the elbow piece whose one end carries a bearing piece on the cowl fitting to be assisted;

the compression spring is applied on a lever which includes a bearing piece on the inner surface of a support of the cowls such as the nacelle pylon;

the assistance device is U-shaped, the lever including a couple of parallel bars and the elbow piece including two parallel portions;

the compression spring includes at least one spring selected particularly among gas springs or helical springs;

the assistance device includes two springs disposed between the U-shaped parallel portions of said elbow piece and the parallel bars of the lever;

the hinge collinear to an existing hinge or butt hinge for a cowl fitting includes a common shaft together with the hinge of the cowl fitting on which is applied the assistance momentum of the compression spring.

The present disclosure also concerns a turbojet engine nacelle or the like, the nacelle being of the type including at least one hinged cowl on a support such as the pylon. The nacelle according to the present disclosure includes at least one device for assisting the lifting of the cowl according to the present disclosure, on at least one hinge of a plurality of hinges of said cowl.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a nacelle portion of the state of the art having two closed lateral cowls;

FIG. 2 shows the nacelle portion of the state of the art having the two cowls of FIG. 1 in the open state;

FIG. 3 shows the nacelle portion on which it is disposed assistance devices according to one form of the present disclosure;

FIGS. 4 to 6 show another form of the present disclosure;

FIG. 7 shows another form of the present disclosure; and

FIGS. 8 and 9 show another form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

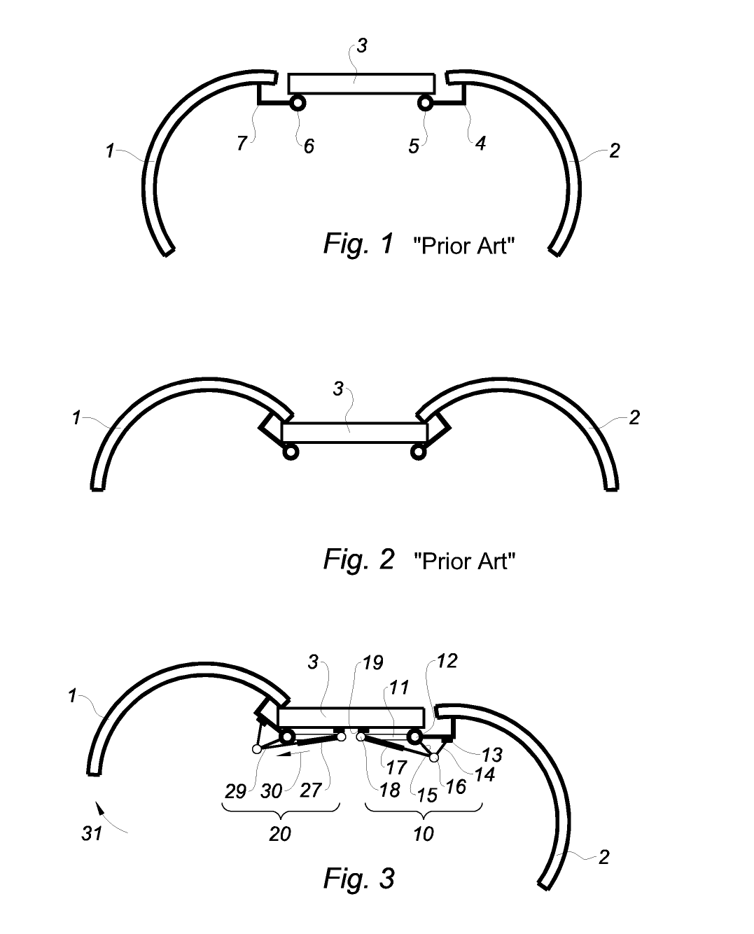

In FIGS. 1 and 2, it is schematically shown a nacelle portion of the state of the art including two closed lateral cowls. The drawing shows a schematic view in partial section with a left cowl 1, a pylon or support 3 and a right cowl 3. The left 1 and the right 2 cowls are hinged on the pylon 3 by a butt hinge 6 or 5 respectively secured from the lower face to the drawing of the pylon 3. Each butt hinge or hinge 6 or 5 carries an elbow fitting 7 or 4 whose end is secured, for example by screwing on the inner face of the left 1 or the right 2 cowl respectively.

When the motor contained in the nacelle is in the operating state, both the left 1 and the right 2 cowls are in the closed state (FIG. 1). When the apparatus equipped with the nacelle is under maintenance or control, maintenance agents can open the left 1 or the right 2 cowl by lifting the free edge (lower in the drawing) so that the left 1 or the right 2 cowl pivots around the hinge 6 or 5 respectively. The nacelle is then shown in FIG. 2, the left 1 and the right 2 cowls in the open state.

As noted hereinabove, the cowl mass, its large size on the most significant nacelles, and the wind resistance on the airport maintenance platforms, prevent an easy operation by a single maintenance agent.

According to the present disclosure, it is possible to add to the existing equipment of the nacelle a device for assisting the operation or the lifting of the cowl by means of limited means, without changing the design of an apparatus and of its nacelle.

In FIG. 3, it is shown one form of such assistance device. The partially shown nacelle includes the same elements as those of FIGS. 1 and 2 and all references of these two Figures are not illustrated therein to clarify the drawing, even though a mention thereof will be made in the following text. Two assistance devices 10 and 20 are illustrated. However, the assistance device 10, mounted on the hinge 5 (identical reference to that of FIG. 1, but not illustrated in FIG. 3) is in the inactive state, the right cowl 2 having remained closed. The assistance device 20, mounted on the hinge 6 (same reference to that of FIG. 1, but not illustrated in FIG. 3) is in the active state, the maintenance operator having operated the left cowl 1 in the open position.

The lifting assistance device 10 of the form of FIG. 3 includes a lever 11 which carries two hinges; respectively on the right a hinge 12, coaxial to the hinge 5 (see FIG. 1), and on the left a hinge 18. The lever 11 in the vicinity of the hinge 12, carries a bearing piece 19 on the inner face (in the drawing) of the pylon or support 3. The bearing piece 19 may if necessary be secured to said inner face of the pylon 3, by bolting or otherwise. But, as will be understood through the following dispositions, the balance of the assistance device when constrained by the cowl weight is improved.

The hinge 12, coaxial with the hinge 5 (FIG. 1), carries an elbow piece 13-15 whose one first portion 15 has one end on the left secured to the hinge 12 and one end on the right secured to another hinge 16. A second portion 14 of the elbow piece 13-15 is secured to the first portion 15 and, if necessary, to the hinge 16 without being however able to rotate relative to the first portion 15. Finally, the right end of the portion 14 carries a bearing piece 13 on a determined portion of the fitting 4 (see FIG. 1). As the bearing piece 19 aforementioned, the bearing piece 13 of the elbow piece 13-15 may, if necessary, be secured to said fitting 4 (FIG. 1), by bolting or otherwise. But, as will be understood through the following dispositions, the balance of the assistance device when constrained by the cowl weight is improved.

Finally, the lifting assistance device of the cowl 10 includes at least one compression spring whose one end is applied on a portion of the elbow piece. In the form of FIG. 3, the application of the spring on the elbow piece bears on a hinge of the elbow piece. In other forms, one end of the compression spring is also applied on a lever. In the described form, the compression spring 17 is mounted by a first end to the aforementioned hinge 18 on the lever 11, while the end of the movable rod of the compression spring 17 is mounted on the right on the hinge 16 secured to the elbow piece 13-15.

In one form, the compression spring 17 may be a gas spring having a cylindrical sealing body at one end of which exit a movable rod, which carries a piston intended to pass through the inner volume of the sealing body under pressure of a gas.

In one form, the cowl 1 or 2 has a mass of 57 kg. The assistance device, the lever 12 and the elbow piece 13-15, may be made of titanium and with a 700 grams gas spring, and it had an overall mass of 1300 grams. The amplitude of the rotational movement of the cowl may be in the range of 60° and the assistance force ranged from 120 N at the beginning of the opening to 340 N in the open position.

It will now be described the operation of the assistance device 20, identical to the assistance device 10, but coupled to the left cowl 1. When the maintenance operator has unlocked the lock (not shown) of the left cowl 1 on the rest of the nacelle (not shown), he grasps its lower edge and makes it go through a rotational movement 31 around the hinge 6 (FIG. 1). At the same time, the gas spring 27 of the assistance device 20 extends its movable rod 29 in the direction 30, adding its released compression force at the time of lifting of the maintenance operator. The elbow piece of the assistance device 20, analogous to the elbow piece 13-15 of the assistance device 10, exerts a compensating momentum on the fitting 7 (FIG. 1) assisting thus the operation of the maintenance operator who can thus act alone.

Bearing only on the lower face of the pylon and on the fitting 7, the assistance device 20 exerts no constraint on a small portion of the nacelle. In addition, by designing acute angles relative to the bearing surfaces on the fitting and on the pylon, the assistance device remains in place due to the bearing pieces, even without the use of fasteners, only lying on the hinge 6 with which the device shares a hinge axis.

The device of the present disclosure has only a minor addition to the embedded devices in the nacelle so that its setting-up may not pose a problem on an existing nacelle. Similarly, its integration at the design of a new nacelle does not lead to additional constraints.

Besides the conformation of the bearing pieces (13 and 19; assistance device 10) with the lower face of the pylon and with the fitting (4; FIG. 1), the assembly of the assistance device of the present disclosure requires only changing the existing hinge on the fitting connecting the cowl to the lower face of the pylon. In practice, this hinge consists of one or more shafts on the hinge axis which engages in the corresponding piercing of the fitting 4 or 7 and of a portion fastened to the lower face of the pylon. In one form, this shaft is removed and replaced by a longer shaft which also engages in the hinge 12 (device 10) secured to the elbow piece 13-15 and to the lever 11. One form will be described further.

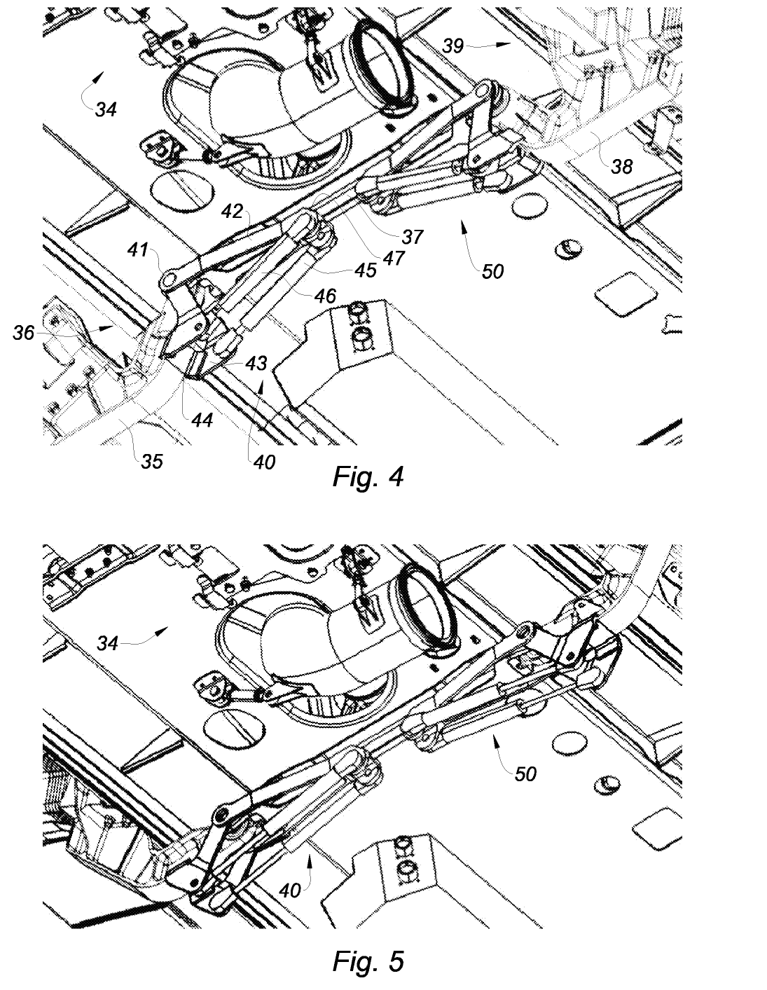

In FIGS. 4 to 7, it is shown three perspective views of another form of the present disclosure, when mounted on an existing nacelle. The concerned nacelle portion is viewed from the front when mounted on the pylon 34. It is shown two assistance devices 40 on the cowl 36 of the left and 50 on the cowl 39 of the right. The cowl 36 of the left is secured to a fitting 35, invisible end of which is hinged by a shaft to a stationary fitting secured to the inner face of the pylon 34. Similarly, the right cowl 39 is secured to a fitting 35 an visible end of which is hinged by a shaft on a stationary fitting secured to the inner face of the pylon 34.

An assistance device 40 is mounted on the fitting 35 of the left cowl 36 and an assistance device 50 is mounted on the fitting 38 of the right cowl 39. The disposition of these two assistance devices may be analogous to that of the form of FIG. 3.

In FIG. 4, the cowls are in the closed position, while they are open in FIG. 5. It is noted the presence of a reinforcing bar 37 which join the stationary fittings secured from the lower face to the nacelle of the pylon, the stationary fittings contributing to the conventional hinge of the left cowl 36 with the fitting 35 and the right cowl 39 with the fitting 38. The particular section of the reinforcing bar 37 drives an adapted profile on the bearing piece 47, analogous to the bearing piece 19 of the assistance device 10 described in FIG. 3.

In the form of FIGS. 4 to 6, the assistance device is U-shaped, so that the lever 11 and the elbow piece 13-15 of the assistance device 10 of the form of FIG. 3 are doubled on the assistance device 40 of the form of FIG. 4. Thus, on the left of the assistance device 40, the equivalent of the lever 11 consists of two parallel bars whose only the front bar 42 is visible and they are joined particularly by the bearing piece 47. Similarly, the spring 17 of the form of FIG. 3 is doubled by two identical springs 45 and 46 and the elbow piece 13-15 is also doubled by two similar and parallel portions of which only the rear portion 43 has been referenced and which are connected by a bearing piece 44 of the fitting 35, the bearing piece 44 being analogous to the bearing piece 13 of the assistance device 10 of the form of FIG. 3. The ends of the two springs 46 and 45 are hinged on suitable hinges respectively of the two portions of the elbow piece 43-44 and of the double lever 42.

Finally, a common shaft 41 of the assistance device 40 together with the fitting 35 enables supporting the assistance device 40 on the nacelle and its assistance operation. In FIG. 5, which is identical to FIG. 4, the two cowls 36 and 39 are shown in the open state, the two assistance devices being in the expanded state, the springs are completely extended.

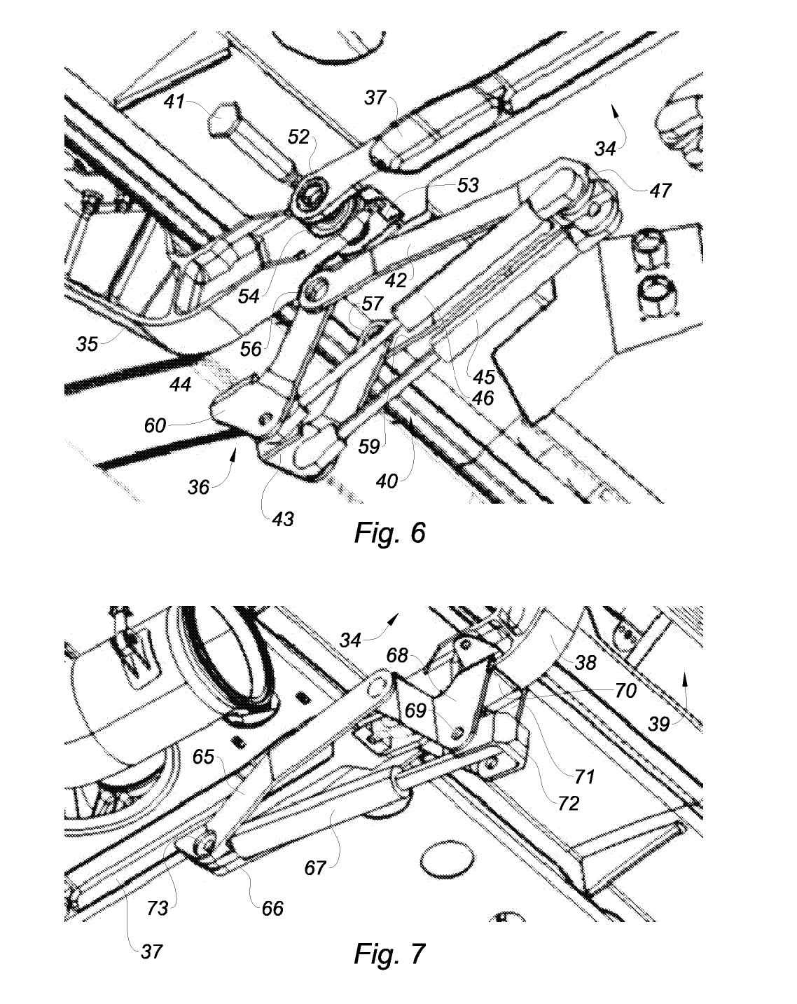

In FIG. 6, it is shown the assistance device 40, just before its assembly on the fitting 35. For this purpose, the original shaft of the fitting 35 hinge on the pylon is removed, the cowl 36 being in the lifted position. The assistance device 40 is placed by the counterpart hinge 56, 57, the two springs 46, 45 being in extended state. It is simply a matter of putting a longer shaft 41 through the piercing 52 provided for this purpose. The two parallel arms of the stirrup consisting of the two parallel 42 front and 59 rear levers are placed so that their left ends carrying piercings 56 and 57 pass to the outside of the stationary fitting of the inner face of the pylon 34. In this form, the stationary fitting of the inner face of the pylon consists of a forked end of the reinforcing bar 37. The two arms of the fork forming the stationary fitting each has a piercing 52 or 53 and surround the fitting 35 end on which is mounted the left cowl 36.

When all of these components are aligned with the common axis of the hinge to be reformed, the shaft 41 is inserted into the piercings set and the change operation of the cowl hinge assembly is achieved, at the same time that the assistance device 40 is installed in the nacelle. It is simply a matter of closing the left cowl 36 to put the two compression springs 46 and 45 in compression and ready to assist the subsequent opening operation.

In FIG. 7, it is shown another form of an assistance device, when it is mounted on the right cowl 39 of the same type of nacelle as that of FIGS. 4 to 6. The assistance device is similarly U-shaped with two bars 65 and 66 joined to the left on a bearing piece 73 on the reinforcing bar 37. The other ends of the bars 65 and 66 which are analogous to the lever 11 of the form of FIG. 3 carry the elbow piece 68-72 consisting of two parallel portions 68 and 71 as in the case of the form of FIGS. 4 to 6. The two parallel portions 68 and 71 of the elbow piece 68-72 are joined by a bearing piece 70 of the fitting 38 mounted on the right cowl 39.

The space between the two parallel portions 68 and 71 of the elbow piece 68-72 receives a cap 72 hinged on an axis 69 passing through the two parallel portions 68 and 71. The cap 72 is intended to receive the free end of the movable rod of a single compression spring 67, whose body 67 is itself hinged to the left on the parallel bars 65 and 66.

The assembly and the operation of the stirrup of the assistance device of the form of FIG. 7 are identical to those of the form of FIGS. 4 to 6.

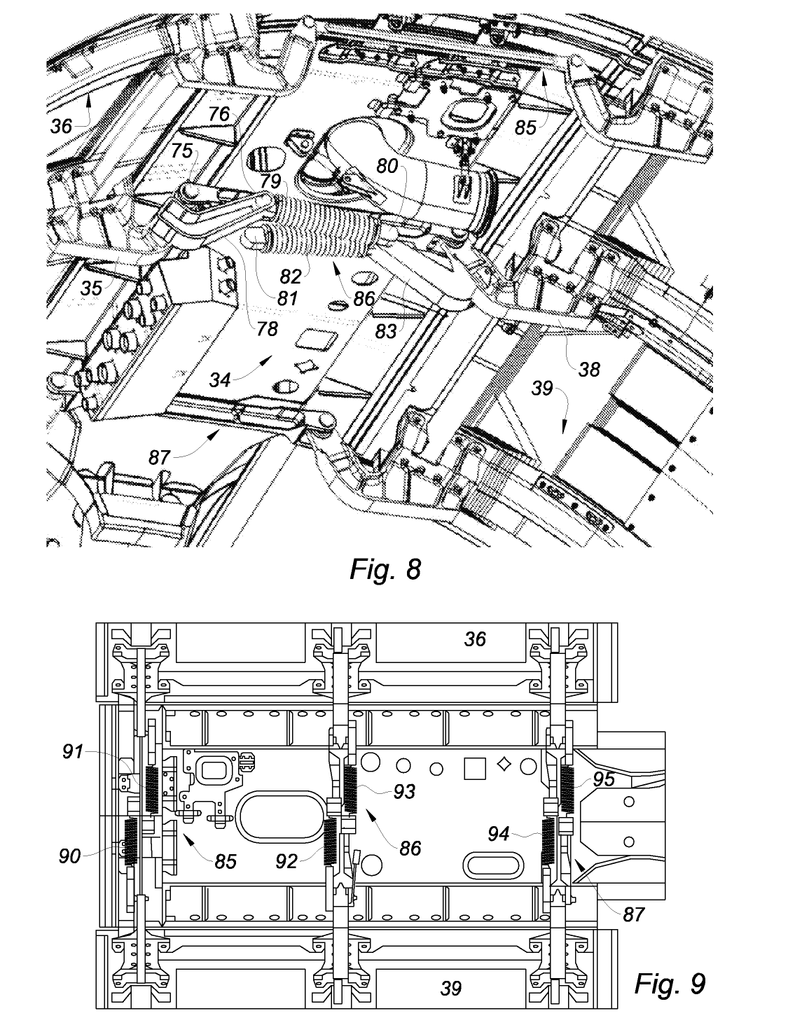

In FIG. 8, it is shown another form of an assistance device according to the present disclosure. The nacelle on which it is installed is identical to that of FIGS. 4 to 7 and has the same reference numbers. It is noticed, however, that the left 36 and the right 39 cowls, each carries three hinged fittings on the forked ends—such as that shown in FIG. 6 on three reinforcing bars 85, 86 and 87. In the form of FIG. 8, a single assistance device is disposed on the hinge of the central reinforcing bar 86. An assistance device 75-80 is mounted on the left according to a similar scheme to that of the form of FIG. 3, on the common hinge 75 together with the fitting 35 of the left cowl 36, while an assistance device 81-83 identical to the left assistance device 75-80 is mounted on the common hinge together with the fitting 38 of the right cowl 39.

The assistance device of this form differs from the previous forms in that it incorporates a helical spring 79 or 82 instead of a gas spring and that it does not get back the form of a stirrup, then being mounted on one side of the axis 75 which forms the common hinge of the elbow piece 78 (respectively 83), of the lever 76 (respectively 81) carrying the helical spring 79 (respectively 82) of the assistance device which acts on the fitting 35 (respectively 38), and the fitting 35 itself on the stationary fitting at the end of the reinforcing bar 86.

In FIG. 9, it is shown a bottom view of the form of FIG. 8, but in which an assistance device has been added to each of the three fittings of both left 36 and right 39 cowls, namely the devices 90, 92 and 94 for the three fittings of the right cowl 39 and the devices 91, 93 and 95 for the three fittings of the left cowl 36.

The devices of the other forms aforementioned can also be distributed over all the fittings and the hinges of either cowls or limited to some of them. The compression springs used to produce the assisted-opening momentum are of all types comprising gas springs and helical springs.

What is claimed is:

1. An assistance device for operating a cowl of a hinged turbojet engine nacelle by means of at least one fitting, said assistance device comprising:
at least one elbow piece mounted on a hinge coaxial to a hinge of said at least one fitting and having an end bearing on said at least one fitting, and
a compression spring applied on said at least one elbow piece to exert an assistance momentum on said at least one fitting of the cowl when the cowl is lifted.

2. The device according to claim 1, wherein the application of the compression spring on said at least one elbow piece includes a hinge of said at least one elbow piece whose one end carries a bearing piece on said at least one fitting of the cowl to be assisted.

3. The device according to claim 1, wherein the compression spring is applied on a lever which includes a bearing piece on an inner surface of a support of the cowl as a pylon of the turbojet engine nacelle.

4. The device according to claim 3, wherein the device is U-shaped, and the lever includes a couple of parallel bars and said at least one elbow piece includes two parallel portions.

5. The device according to claim 1, wherein the compression spring includes at least one spring selected from at least one of gas spring or a helical spring.

6. The device according to claim 5, wherein the device includes two springs disposed between U-shaped parallel portions of said at least one elbow piece and parallel bars of a lever.

7. The device according to claim 1, wherein a hinge collinear to an existing hinge or a butt hinge for a fitting of the cowl includes a common shaft together with the hinge of said at least one fitting on which is applied the assistance momentum of the compression spring.

8. A nacelle for a turbojet engine, the nacelle being of the type including at least one hinged cowl on a support, wherein the nacelle includes at least one device for assisting the lifting of the cowl according to claim 1, on at least one hinge of a plurality of hinges of said at least one hinged cowl.
